(19) United States
(12) Patent Application Publication
(10) Pub. No.: US 2019/0312484 A1
(43) Pub. Date: Oct. 10, 2019

(54) BRUSHLESS DIRECT-CURRENT ELECTRIC MOTOR FOR A WIPER SYSTEM OF A MOTOR VEHICLE

(71) Applicant: Valeo Systèmes d'Essuyage, Le Mesnil Saint Denis (FR)

(72) Inventor: Jose-Luis Herrada, Le Mesnil Saint Denis (FR)

(73) Assignee: Valeo Systèmes d'Essuyage, Le Mesnil Saint Denis (FR)

(21) Appl. No.: 16/335,921

(22) PCT Filed: Jul. 19, 2017
(86) PCT No.: PCT/EP2017/068196

§ 371 Date: Mar. 22, 2019

(30) Foreign Application Priority Data
Sep. 26, 2016 (FR) 1659036

(51) Int. Cl. H02K 7/08; H02K 5/173; H02K 7/116; B60S 1/08; B60S 1/26; B60S 1/28; F16H 1/16

(52) U.S. Cl. CPC H02K 7/081; H02K 5/1735; H02K 7/1166; B60S 1/08; F16C 19/06; B60S 1/28; F16H 1/16; H02K 2207/03; F16C 2380/27; B60S 1/26

(57) ABSTRACT

The invention relates to a geared motor (1) for a wiper system of a motor vehicle, comprising a brushless direct-current electric motor (2) comprising: a rotor (20) comprising magnetic elements (29); a stator (21) comprising coils for the electromagnetic excitation of the rotor; a rotating shaft (22) secured to the rotor; a reducing mechanism (3) connecting the rotating shaft (22) and an output shaft (8) of the geared motor; and a housing (4) forming a protective envelope for the electric motor (2) and said reducing mechanism (3). According to the invention, a bearing (23) guides the rotating shaft (22) on one of the longitudinal ends of the rotating shaft, said bearing (23) being arranged inside the rotor (20) and stator (21) assembly and housed in a recess inside the rotor (20), the envelope of the housing (4) comprising an inwardly projecting part (40) penetrating said inner recess and carrying a seat (41) for said bearing (23).

The present invention relates to a gear motor for a motor vehicle wiper system, and a wiper system comprising such a gear motor.

Gear motors are essentially composed of an electric motor coupled to a speed-reducing mechanism designed to gear down the speed to obtain a significant rotational transmission torque.

Different types of electric motors can be used in a gear motor and in particular the brushless direct current electric motors which offer many advantages such as a long life, a small bulk and low consumption as well as sound level.

However, controlling the electric motors is more complex compared to the electric motors with brushes because, to allow for correct operation, it is necessary to know precisely the angular position of the rotor of the brushless direct-current electric motor.

In fact, such electric motors comprise electromagnetic excitation coils arranged on the stator and powered by alternating current via an inverter to allow the rotor to be driven.

Now, in order to be able to switch over the switches of the inverter (generally six switchovers with each revolution of the rotor) and therefore power the electromagnetic coils at optimal instants to make it possible to obtain the desired driving of the rotor, the position of the rotor needs to be known at each instant. To this end, the position of the rotor and its angular speed are very often determined through the use of the signals generated by a device which comprises a multiple-pole magnet, mounted to rotate with the rotor, and Hall effect sensors arranged at fixed positions relative to the magnet.

The document WO 2016/010023 discloses such a gear motor for a motor vehicle wiper system using a brushless direct-current motor. The brushless motor comprises a stator having electromagnetic rotor excitation coils, and the rotor is rigidly mounted at the edge of a rotation shaft. This rotation shaft extends from a casing part for the rotor/stator assembly to a part of the casing receiving the speed-reducing mechanism which is a worm screw gear.

The screw of the gear is secured to the rotation shaft of the rotor and meshes with the toothed wheel secured to the output shaft of the gear motor.

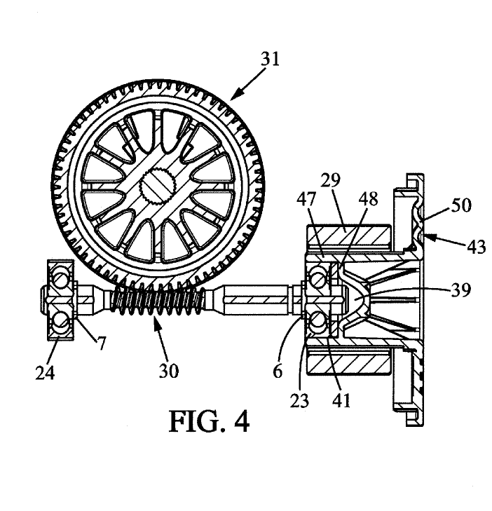

Notably, and as can be seen in FIG. 4 (or in FIG. 8) of the document WO 2016/010023, only two ball bearings are used to rotationally guide the rotation shaft of the rotor, with, on the one hand, a first ball bearing, referenced 39 supporting a central part of the rotation shaft, intermediate between the rotor and the worm screw, and, on the other hand, a second rolling bearing at the longitudinal end of the shaft arranged on the other side of the worm screw relative to the first rolling bearing.

In particular, the part of length of the rotation shaft extending from the first rolling bearing to the rotor is guided only by the first rolling bearing, the longitudinal end of the shaft emerging on the other side of the rotor being free of guidance.

Such a guidance by means of only two rolling bearings differs from the standard practice which conventionally uses a third rolling bearing to rotationally guide the distal end of the shaft in proximity to the rotor. According to the observations of the inventor, such guidance of the shaft using only two rolling bearings makes it possible to limit the bulk of the gear motor in the direction of the shaft. On the other hand, the omission of the third rolling bearing is not ideal in terms of mechanical stresses, this defect being potentially the origin of the appearance of vibrations when the rotor is rotated.

What is more, in the known state of the art, whether the guidance of the shaft is with two rolling bearings or with three rolling bearings as previously cited, it is standard practice to always provide one rolling bearing at an intermediate position over the length of the rotation shaft, in proximity to the worm screw, and another rolling bearing on the longitudinal end of the shaft on the other side of the worm screw. Such guidance by the positioning of the rolling bearing as close as possible to the worm screw makes it possible to limit the deflection of the rotation shaft in this meshing part, and in order to ensure a satisfactory operation of the speed-reducing mechanism, without risk of the meshing slipping.

In the document WO 2016/010023, the intermediate rolling bearing referenced 39 is arranged in proximity to the multiple-pole magnet of the device ensuring the determination of the position of the rotor. Limiting the deflection of the shaft also makes it possible to keep the radial separation between the multiple-pole magnet and each Hall effect sensor within acceptable tolerances, so as to ensure the correct operation of the sensor device.

The aim of the present invention is to mitigate the abovementioned drawbacks by proposing a gear motor for a motor vehicle wiper system in which the guidance of the shaft of the motor makes it possible to obtain a good compactness on the longitudinal axis of the rotation shaft, and without sacrificing the dynamic balancing of the electric motor.

Other aims and advantages of the invention will emerge from the following description which is given purely by way of indication and which is not intended to limit it.

So, the invention relates to a gear motor for a motor vehicle wiper system comprising:
a brushless direct-current electric motor comprising:
   a rotor, comprising magnetic elements,
   a stator having electromagnetic rotor excitation coils,
   a rotation shaft secured to the rotor,
a speed-reducing mechanism linking the rotation shaft and an output shaft of the gear motor,
a casing forming a protective jacket for the electric motor and said speed-reducing mechanism
   and in which a rolling bearing ensures the guiding of the rotation shaft at one of the longitudinal ends of the rotation shaft, said rolling bearing arranged internal to the rotor and stator assembly, housed in a recess internal to the rotor, and in which the jacket of the casing comprises an inwardly-protruding part, penetrating into said internal recess, and supporting a seat for said rolling bearing.

According to optional features of the invention, that can be taken alone or in combination:
the protruding part comprises a tubular wall, extending coaxially to the rotation shaft, the seat for the rolling bearing being formed at the distal end of the protruding part by a housing for the rolling bearing defined by the internal cylindrical surface of the tubular wall, and a shoulder extending radially inward from the cylindrical surface of the tubular wall;
the shoulder-forming wall is extended to totally block the hollow of the protruding part;
the wall of the shoulder that is extended to totally block the hollow of the protruding part forms an excess depth cavity of the housing for the rolling bearing, this cavity receiving a part of the end of the rotation shaft emerging from the rolling bearing;
the casing comprises, on the one hand, a part of the jacket, receiving at least the rotor and the stator of the electric motor, offering a lateral opening to the electric motor, and, on the other hand, a closing flange ensuring the removable closure of said lateral opening, and in which said protruding part of the casing is borne by the closing flange;
the closing flange comprises a wall in the form of a disk extending laterally to the stator and rotor assembly, having a peripheral rim that cooperates tightly with a complementary edge of said lateral opening, and wherein said protruding part extends from this wall in the form of a disk toward the interior of the internal recess;
the wall in the form of a disk and the protruding part of the closing flange are composed of an element made of a single piece;
said element made of a single piece is a cast metal part;
the electric motor comprises a hollow support bearing the magnetic elements of the rotor, coaxial and secured in rotation to the rotation shaft, said hollow support capping said protruding part of the casing as well as the rolling bearing ensuring the guiding of the longitudinal end of the rotation shaft on the side of the electric motor by extending axially beyond the longitudinal end of the rotation shaft, on the electric motor side;
the hollow support comprises a sleeve ensuring the fixing of the hollow support onto the rotation shaft in a position on the shaft that is intermediate between the speed-reducing mechanism and the rolling bearing ensuring the guiding of the longitudinal end of the rotation shaft on the side of the electric motor;
the rotational guiding of the rotation shaft is ensured only by two rolling bearings arranged at the two longitudinal ends of the rotation shaft, including said rolling bearing borne by the producing part on the side of the electric motor, and another rolling bearing at the other longitudinal end of the rotation shaft, on the speed-reducing mechanism side;
the speed-reducing mechanism comprises a worm screw/toothed wheel system, the worm screw being secured to the rotation shaft of the rotor, the toothed wheel being secured to the output shaft of the gear motor.

The invention relates also to a motor vehicle wiper system comprising one or more windscreen wipers, a linkage mechanism for driving the windscreen wiper or wipers in a reciprocal motion, and a gear motor according to the invention whose output shaft drives the linkage mechanism.

The invention will be better understood on reading the following description accompanied by the attached drawings, in which:

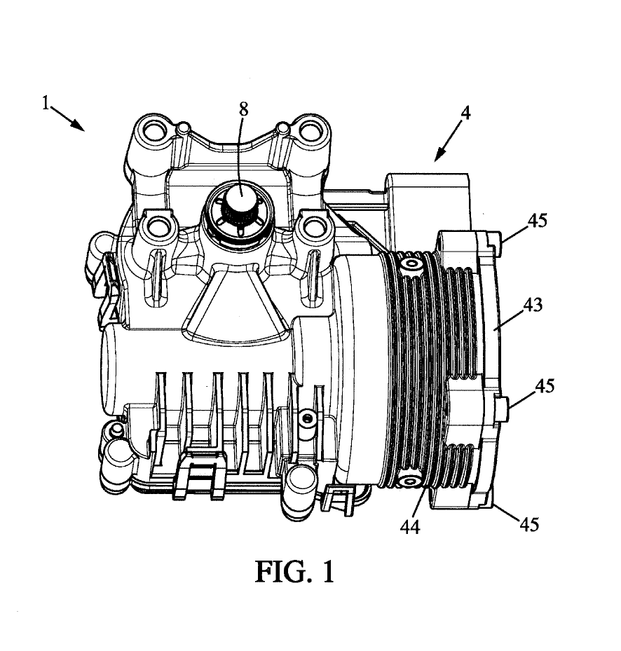

FIG. 1 is a perspective view of a gear motor conforming to the invention according to an embodiment,

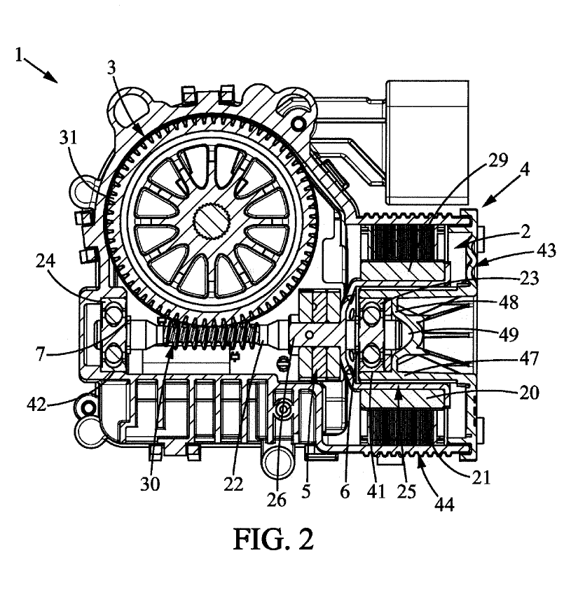

FIG. 2 is a cross-sectional view on a plane passing through the axis of the rotation shaft of the rotor of the electric motor of the gear motor of FIG. 1,

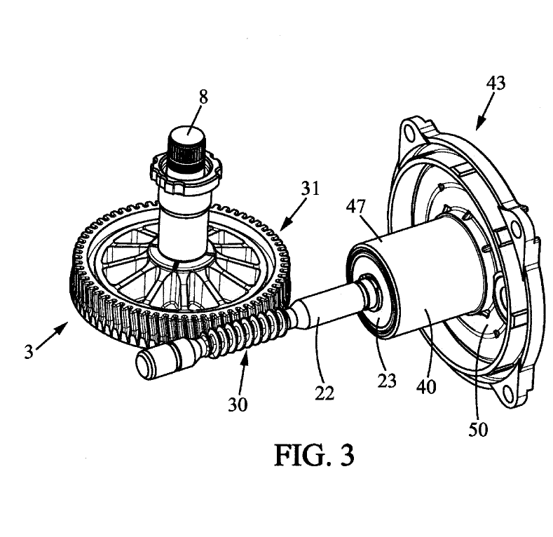

FIG. 3 is a partial view of the gear motor of FIG. 1, illustrating in detail the closing flange, including the protruding part of the casing, the rotation shaft and the speed-reducing mechanism,

FIG. 4 is a partial view of the view of FIG. 2.

Thus, the invention relates to a gear motor 1 for a motor vehicle wiper system comprising:
a brushless direct-current electric motor 2 comprising:
   a rotor 20, having magnetic elements 29, such as permanent magnets, distributed about the axis of the rotor, typically of alternate polarities,
   a stator 21 having electromagnetic rotor excitation coils,
   a rotation shaft 22 secured to the rotor,
a speed-reducing mechanism 3 linking the rotation shaft 22 and an output shaft 8 of the gear motor,
a casing 4 forming a protective jacket for the electric motor 2 and said speed-reducing mechanism 3.

Such a gear motor comprises a device for determining the angular position of the rotor 20 relative to the stator 21. A control unit (not illustrated) is configured to generate control signals to power the electromagnetic excitation coils of the stator 21 according to the angular position of the rotor determined by the device for determining the angular position of the rotor.

According to one embodiment, the device for determining the angular position of the rotor can comprise a multiple-pole magnet 5 secured in rotation to the rotor, and one or more Hall effect sensors (not illustrated) at fixed positions, capable of detecting the changes of magnetic fields of the multiple-pole magnet during the rotation of the rotor.

According to one embodiment, the speed-reducing mechanism 3 can comprise a worm screw 30/toothed wheel 31 system, the worm screw being secured to the rotation shaft 22 of the rotor 20, the toothed wheel 31 being secured to the output shaft 8 of the gear motor. This output shaft 8 is substantially at right angles to the rotation shaft 22 of the electric motor 2. The thread of the worm screw 20 can be obtained from the material of the rotation shaft 22, typically metal.

A rolling bearing 23 ensures the guiding of the rotation shaft 22 at one of the longitudinal ends of the rotation shaft, on the electric motor side. Notably, this rolling bearing 23 is arranged internal to the rotor 20 and stator 21 assembly, housed in a recess internal to the rotor 20.

This end of the rotation shaft can thus advantageously be guided by the rolling bearing 23, without requiring a length of shaft such that its end emerges beyond the rotor. Also, the mounting of this rolling bearing 23 internal to the rotor does not require the provision of a reach on the section of useful length of the rotation shaft external to the rotor, and which is already used to support the worm screw and/or to support the multiple-pole magnet 5: this section of length of the shaft external to the rotor can be reduced to the minimum, and in order to augment the compactness of the gear motor.

To this end, the jacket of the casing 4 comprises an inwardly-protruding part 40, penetrating into said recess internal to the rotor 3, and supporting a seat 41 for said rolling bearing 23. The protruding part 40 can comprise a tubular wall 47, extending coaxially to the rotation shaft 22, the seat 41 for the rolling bearing being formed at the distal end of the protruding part 40 by a housing for the rolling bearing 23. This housing can be defined by the inner cylindrical surface of the tubular wall 47, and a shoulder 48 extending radially inward from the cylindrical surface 17. The rolling bearing 23 comprises an outer ring, an inner ring, and rolling elements, such as balls, the seat 41 of the casing 4 can be of a diameter fitted to the outer ring of the rolling bearing 23. It should also be noted that the shoulder-forming wall 48 can be extended to totally block the hollow of the protruding part, if necessary by forming an excess depth cavity 49 of the housing for the following bearing 23: this excess depth cavity 49 is intended to receive a part of the end of the rotation shaft, emerging slightly from the rolling bearing 23. An elastic ring 6, received in a groove of the rotation shaft 22, can make it possible to block the position of the rolling bearing 23 in the corresponding seat 41 of the casing 4.

According to one embodiment, the casing 4 can comprise, on the one hand, a jacket part 44, in particular cylindrical, receiving at least the rotor 20 and the stator 21 of the electric motor 2, offering a lateral opening to the electric motor 2, and, on the other hand, a closing flange 43 ensuring the removable closure of said lateral opening. According to one embodiment, said protruding part 40 of the casing 4 can be borne by the closing flange 43. The jacket part 44 can be a base, notably made of metal, having fins intended to facilitate the dissipation of the heat.

When the closing flange 43 is removed, the lateral opening allows the removal of the components of the electric motor, such as the rotor 20, the stator 21, the rotation shaft 22 in particular. This closing flange 43 can comprise a wall in the form of a disk 50 extending laterally to the stator and rotor assembly and having a peripheral rim that cooperates tightly with a complementary edge of said lateral opening. Said protruding part 40 extends from this wall in the form of a disk toward the interior of the internal recess. This wall in the form of a disk and the protruding part 40 of the closing flange 43 can be composed of an element made of a single piece, in particular metal.

The securing of the closing flange 43 against the part 44 can be obtained via fixing members 45 passing through lugs of the closing flange 43, typically screwed into tapped holes of the jacket part 44.

The electric motor 2 can comprise a hollow support 25 bearing the magnetic elements 29 of the rotor 20 (permanent magnets and/or windings), coaxial and secured in rotation to the rotation shaft 22, said hollow support 25 capping said protruding part 40 of the casing 4, as well as the rolling bearing 23 ensuring the guiding of the longitudinal end of the rotation shaft 20 on the side of the electric motor 2. This hollow support 25 can also extend axially beyond the longitudinal end of the rotation shaft 22, on the electric motor side.

The hollow support 25 is a body of revolution which comprises a hollow, tubular part, of internal diameter that makes it possible to internally house therein the rolling bearing 23 and the protruding part 40 of the casing 4, and onto the outer circumference of which are secured the magnetic elements of the rotor. This hollow support 25 can also comprise a sleeve 26 making it possible to fix the hollow support 25 onto the rotation shaft 22. This sleeve 26 is fixed in a position on the rotation shaft 22 that is intermediate between the speed-reducing mechanism 3 and the rolling bearing 23. The internal diameter of the sleeve 26 can be fitted to the rotation shaft at this intermediate position. It can be a tight fitting allowing assembly by shrinkage between the hollow support 25 and said rotation shaft 22.

It would be noted that the multiple-pole magnet 5 can take the form of one or more rings mounted around the rotation shaft. The magnetic fields (north/south) extend alternately along the circumference of the ring. This multiple-pole magnet 5 can be secured to said hollow support 25, arranged around said fixing sleeve 26 of said hollow support 25.

According to one embodiment, the rotational guiding of the rotation shaft 22 is ensured only by two rolling bearings 23, 24 arranged at the two longitudinal ends of the rotation shaft 22, namely, on the one hand, said rolling bearing 23, on the side of the electric motor, borne by the seat 41 of the protruding part 40 and, on the other hand, another rolling bearing 24 at the other longitudinal end of the rotation shaft 22, on the side of the speed-reducing mechanism 3.

Each rolling bearing 23 or 24 comprises an outer ring, an inner ring, and rolling elements, such as balls. For each longitudinal end of the rotation shaft, the inner ring of the corresponding rolling bearing 23 (or 24) can be of an internal diameter fitted to the outer diameter of the shaft at the corresponding longitudinal end.

A second seat 42, of a diameter fitted to the outer ring, receives the rolling bearing 24 ensuring the guiding of the other longitudinal end of the rotation shaft 22, on the speed-reducing mechanism side. The blocking of the axial position of one and/or the other of the two rolling bearings 23, 24 on the rotation shaft 22 can be ensured using an elastic ring 6, 7 received in a groove of the rotation shaft 22.

The elastic ring 6, called first elastic ring, is received in a first groove of the rotation shaft 22 and can make it possible to block the position of the rolling bearing 23 in the corresponding seat 41 of the casing 4. A second elastic ring 7 received in a groove of the rotation shaft 22 blocks the axial position of the other rolling bearing 24 in the other seat 42 of the casing 4. The two elastic rings 6 and 7 can respectively engage in abutment with the two rolling bearings 23 and 24, on the internal side, in order to prevent their convergence on the rotation shaft 22.

Note that the diameter of the rotation shaft 22 at the longitudinal ends supported by the two rolling bearings 23, 24 can be greater than the diameter of the shaft at the worm screw 30. It is thus possible to augment the flexural strength of the rotation shaft 22, by an average increase in the diameter of the rotation shaft. A satisfactory operation of the speed-reducing mechanism is still obtained, in particular without risk of slip between the screw 30 and the wheel 31 of the meshing of the speed-reducing mechanism, and even though the guiding of the rotation shaft is without guiding bearing on a central portion of the shaft.

The invention relates also to a motor vehicle wiper system comprising one or more windscreen wipers, a linkage mechanism for driving the windscreen wiper or wipers in a reciprocal motion, as well as a gear motor according to the invention whose output shaft 8 drives the linkage mechanism.

In such a system, the continuous rotational movement of the output shaft 8 is converted by the linkage mechanism into a reciprocal motion of the windscreen wiper or wipers.

### PARTS LIST

1. Gear motor,
2. Electric motor,
20. Rotor,
21. Stator,
22. Rotation shaft,
23,24. Rolling bearings,
25. Hollow support,
26. Fixing sleeve (hollow support),
29. Magnetic elements,
3. Speed-reducing mechanism,
30. Worm screw,
31. Toothed wheel,
4. Casing,
40. Protruding part,
41,42. Seats (rolling bearings),
43. Closing flange,
44. Jacket part (base),
45. Fixing member (screw),
47. Tubular wall (protruding part 40),
48. Shoulder,
49. Excess depth cavity,
50. Wall in the form of a disk
5. Multiple-pole magnet,
6,7. Elastic rings,
8. Output shaft (gear motor).

1. A gear motor for a motor vehicle wiper system, comprising:
a brushless direct-current electric motor comprising:
a rotor comprising magnetic elements,
a stator having electromagnetic rotor excitation coils,
a rotation shaft secured to the rotor,
a speed-reducing mechanism linking the rotation shaft and an output shaft of the gear motor, and
a casing forming a protective jacket for the electric motor and said speed-reducing mechanism,
wherein a rolling bearing ensures guiding of the rotation shaft at one of the longitudinal ends of the rotation shaft, said rolling bearing, arranged internal to the rotor and stator assembly, housed in a recess internal to the rotor, and
wherein the jacket of the casing comprises an inwardly-protruding part, penetrating into said internal recess, and supporting a seat for said rolling bearing.

2. The gear motor as claimed in claim 1, wherein the inwardly-protruding part comprises a tubular wall, extending coaxially to the rotation shaft, the seat for the rolling bearing being formed at the distal end of the inwardly-protruding part by a housing for the rolling bearing defined by the inner cylindrical surface of the tubular wall, and a shoulder extending radially inward from the cylindrical surface of the tubular wall.

3. The gear motor as claimed in claim 2, wherein the shoulder-forming wall is extended to totally block the hollow of the protruding part.

4. The gear motor as claimed in claim 3, wherein the wall of the shoulder (48) that is extended to totally block the hollow of the inwardly-protruding part forms an excess depth cavity of the housing for the rolling bearing, the cavity receiving a part of the end of the rotation shaft emerging from the rolling bearing.

5. The gear motor as claimed in claim 1, wherein the casing comprises a jacket part receiving at least the rotor and the stator of the electric motor, offering a lateral opening to the electric motor, and a closing flange ensuring the removable closure of said lateral opening, and wherein said inwardly-protruding part of the casing is borne by the closing flange.

6. The gear motor as claimed in claim 5, wherein the closing flange comprises a wall in the form of a disk extending laterally to the stator and rotor assembly, having a peripheral rim that cooperates tightly with a complementary edge of said lateral opening, and wherein said inwardly-protruding part extends from this wall in the form of a disk to the interior of the internal recess.

7. The gear motor as claimed in claim 6, wherein the wall in the form of a disk and the inwardly-protruding part of the closing flange are composed of an element made of a single piece.

8. The gear motor as claimed in claim 7, wherein said element made of a single piece is a cast metal part.

9. The gear motor as claimed in claim 1, where the electric motor further comprises a hollow support bearing the magnetic elements of the rotor, coaxial and secured in rotation to the rotation shaft, said hollow support capping said inwardly-protruding part of the casing as well as the rolling bearing ensuring the guiding of the longitudinal end of the rotation shaft on the side of the electric motor by extending axially beyond the longitudinal end of the rotation shaft, on the electric motor side.

10. The gear motor as claimed in claim 9, wherein the hollow support comprises a sleeve ensuring the fixing of the hollow support onto the rotation shaft in a position on the shaft that is intermediate between the speed-reducing mechanism and the rolling bearing ensuring the guiding of the longitudinal end of the rotation shaft on the side of the electric motor.

11. The gear motor as claimed in claim 1, wherein the rotational guiding of the rotation shaft is ensured only by two rolling bearings arranged at the two longitudinal ends of the rotation shaft, including said rolling bearing borne by the inwardly-protruding part on the side of the electric motor, and another rolling bearing at the other longitudinal end of the rotation shaft, on the side of the speed-reducing mechanism.

12. The gear motor as claimed in claim 1, wherein the speed-reducing mechanism comprises a worm screw and toothed wheel system, the worm screw being secured to the rotation shaft of the rotor, the toothed wheel being secured to the output shaft of the gear motor.

13. A motor vehicle wiper system comprising:
one or more windscreen wipers;
a linkage mechanism for driving the windscreen wiper or wipers in a reciprocal motion; and
a gear motor as claimed in claim 1 whose output shaft drives the linkage mechanism.
